(19) United States
(12) Patent Application Publication
(10) Pub. No.: US 2017/0130915 A1
(43) Pub. Date: May 11, 2017

(54) TRACK STRIP LIGHT

(71) Applicant: DONGGUAN JIASHENG LIGHTING TECHNOLOGY CO., LTD., DONGGUAN CITY (CN)

(72) Inventor: Shuisheng XU, DONGGUAN CITY (CN)

(21) Appl. No.: 15/349,204

(22) Filed: Nov. 11, 2016

(30) Foreign Application Priority Data
Nov. 11, 2015 (CN) 201520898919.7

(51) Int. Cl. F21S 8/00; F21V 29/508; F21V 23/02; F21V 29/83; F21V 19/00; F21S 4/28; F21V 21/005; F21V 29/503; F21V 23/00

(52) U.S. Cl. CPC F21S 8/038; F21V 29/503; F21V 29/508; F21V 23/023; F21V 23/004; F21V 19/0015; F21S 4/28; F21V 21/005; F21V 29/83; F21W 2121/00

(57) ABSTRACT

Disclosed is a track strip light, comprising a rack strip, LED strip lights and track spotlights, wherein both the LED strip lights and the track spotlights are mounted on the track strip and can freely move on the track strip to allow the positions thereof to be adjusted according to actual requirements; grooves are provided on inner side faces inside the track strip; each of the LED strip lights comprises a housing, an LED light bar and a driving power supply, the housing comprising a lower housing and an upper housing, the lower housing and the upper housing forming an accommodation space in which the LED light bar and the driving power supply are mounted; and, a track switch is provided on the LED strip light, and the LED strip lights are fixed on the track strip or removed from the track strip by rotating the track switch.

### FIELD OF THE INVENTION

The present patent relates to a lighting lamp, and in particular to a track strip light which may simultaneously realize the functions of accent lighting and basic lighting.

### BACKGROUND OF THE INVENTION

Track lights are lamps used for the interior design or used in an exhibition stand for projecting a light source to exhibit objects. In order to allow the objects to be irradiated by light sources from different angles to make their features prominent, the lamps must be mounted on one track strip to adjust the change in shadow and the angle at any time. Thus, on one hand, the exhibited objects may be viewed by visitors more clearly; and on the other hand, by virtue of the projection by the light, the exhibited objects in the showcases look better in texture, so that the sense of worth of the exhibited objects is improved. However, conventional track lights are merely provided with track spotlights. The light source emitted by such a track light is relatively concentrated and merely used for concentrating the illumination light on the exhibited objects. If it is intended to enhance the overall brightness of the showcase, there is a room for improvement.

### SUMMARY OF THE INVENTION

Based on this, in view of the deficiencies in the prior art, it is necessary to provide a track strip light having a lighting source and a projection light source.

A track strip light is provided, including a track strip, a number of LED strip lights and a number of track spotlights, wherein both the LED strip lights and the track spotlights are mounted on the track strip, and can freely move on the track strip to allow the positions thereof to be adjusted according to actual requirements; grooves are provided on two inner faces inside the track strip; each of the LED strip light includes a housing, an LED light bar and a driving power supply, the housing including a lower housing and an upper housing adapted onto the lower housing, the lower housing and the upper housing forming an accommodation space in which the LED light bar and the driving power supply are mounted; a track switch is provided on the LED strip light, and a snap-in member is provided on the track switch; when the LED strip lights are mounted, the LED strip lights are embedded into the track strip, and the rack switch is rotated so that the snap-in portion is snapped into the grooves of the track strip, and accordingly, the LED strip lights are fixed inside the track strip; and, when it is to remove the LED strip lights, the track switch is rotated back to the original position, and the snap-in portion comes out from the grooves, so that the LED strip lights can be removed, and it is convenient for disassembly and assembly.

Further, the lower housing is detachably mounted on the upper housing, and the lower housing is made of a transparent material.

Further, a boss is convexly provided in the middle of the top of the upper housing, and the top of the boss is in close fit with an inner wall of the track strip.

Further, a mounting portion is provided on an inner top surface of the upper housing, the LED light bar is fixed on the mounting portion by a fastener, and the driving power supply is mounted inside the boss.

Further, a number of first ventilation holes are provided on a top surface of the boss, and heat generated by the driving power supply is dissipated from the first ventilation holes.

Further, a number of second ventilation holes are provided within a region other than the boss on the top surface of the upper housing, and heat generated by the LED light bar is dissipated from the second ventilation holes.

Further, the track switch is arranged on the top surface of the upper housing of the LED strip lights; and the snap-in member comprises a number of elastic sheets, one end of each of which is fixed on the LED strip lights while the other end thereof is snapped into the groove on the inner side face of the track so that the LED strip lights are fixed in the track strip.

Further, grooves are provided on two side faces of the track strip; and the snap-in member comprises two elastic sheets which are arranged horizontally in opposite directions, and the two electric sheets are embedded into the grooves on the two inner side faces of the track strip, respectively.

Further, a hook is provided on the lower housing, a hole matched with the hook is provided on the upper housing, and the hook is buckled in the hole.

Further, the track strip is made of aluminum.

Further, the driving power supply includes a PCB board; insert elements are provided on a front surface of the PCB board, while SMD elements connected to the insert elements are provided on a rear surface thereof; and the insert elements are a resistor, an inductor, a metal film capacitor, an MOS transistor or a capacitor.

Compared with the prior art, in the track strip light provided by the present patent, by providing track spotlights and LED strip lights and mounting both the track spotlights and the LED strip lights inside the track strip, the characteristics and space of the track strip is fully utilized; the track strip light may realize general lighting while realizing accent lighting; the mounting space is saved; and it is easy to disassemble and assemble. In addition, in the track strip light, the number of lamps can be increased or reduced according to the height of a track, and the positions of the LED strip lights and the track spotlights can be arbitrarily adjusted according to actual requirements, leading to high flexibility.

### BRIEF DESCRIPTION OF THE DRAWINGS

FIG. 1 is a schematic structure diagram of a track strip light according to the present patent;

FIG. 2 is a schematic structure diagram of a track strip light according to the present patent, where track spotlights are not shown;

FIG. 3 is an exploded view of FIG. 2;

FIG. 4 is a sectional view of an LED strip light in the track strip light of FIG. 1; and

FIG. 5 is a top view of an LED strip light in the track strip light of FIG. 1.

### DETAILED DESCRIPTION OF THE PREFERRED EMBODIMENTS

To make the objectives, technical solutions and advantages of the present patent clearer, the present patent will be further described below in details with reference to the accompanying drawings.

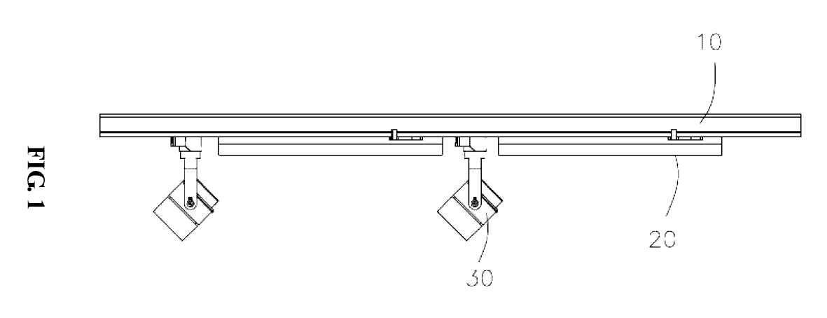

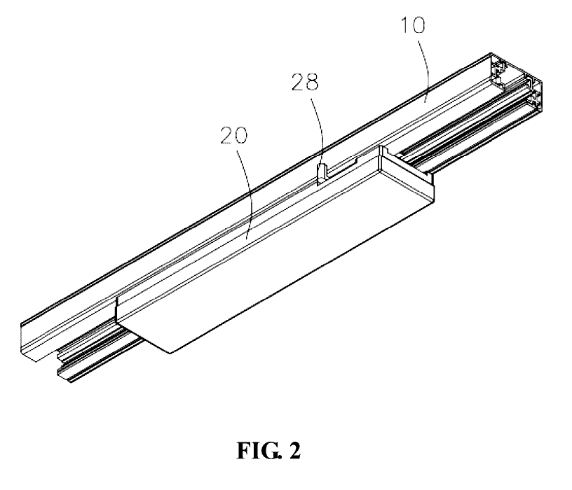

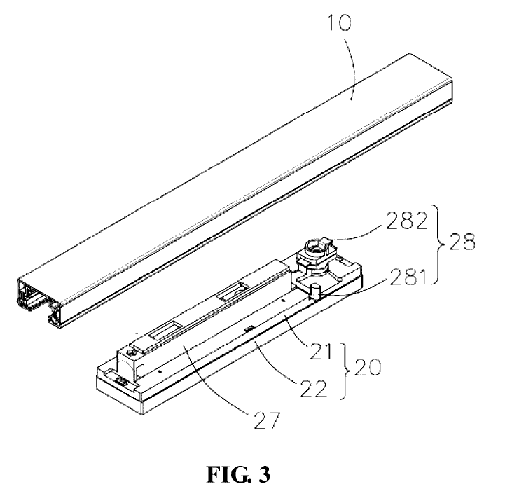

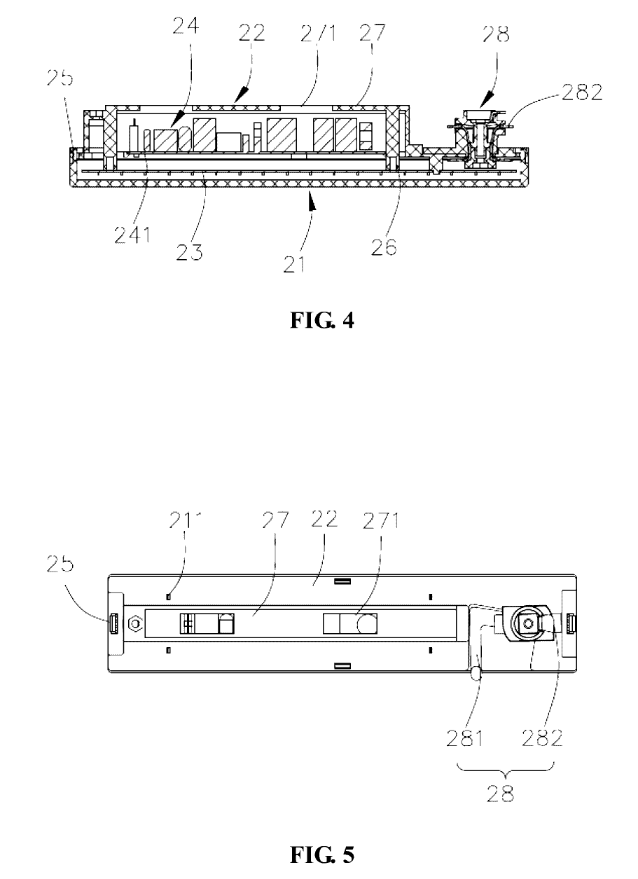

As shown in FIGS. 1-4, the present patent provides a track strip light, including a track strip 10, a number of LED strip lights 20 and a number of track spotlights 30. Both the LED strip lights 20 and the track spotlights 30 are mounted on the track strip 10, and can freely move on the track strip 10 to allow the positions thereof to be adjusted according to actual requirements.

The track strip 10 is in an elongated shape and made of aluminum. As the aluminum material has an excellent heat conductivity, heat generated by the LED strip lights 20 may be quickly transferred to the track strip 10 and then dissipated from the track strip 10 to the outside air.

Each of the LED strip lights comprises an upper housing 22, a lower housing 21, an LED light bar 23 and a driving power supply 24. The upper housing 21 and the lower housing 22 form an accommodation space in which both the LED light bar 21 and the driving power supply 24 are accommodated. The driving power supply 24 supplies power to the LED light bar 23. Hooks 25 are provided on four peripheral edges of the lower housing 22, and holes (not shown) are provided, on the upper housing 21, at positions corresponding to the hooks 25. The hooks 25 are snapped into the holes so that the upper housing 21 and the lower housing 22 are mounted more stably. A mounting portion 26 is provided inside the upper housing 21, and the LED light bar 23 is mounted on the mounting portion 26 by a fastener. The lower housing 22 is made of a transparent material so that light emitted by the LED light bar 23 may pass through the lower housing 22.

A boss 27 is convexly provided at a middle position on the top of the upper housing 21, and the driving power supply 24 is mounted inside the boss 27. The top surface of the boss 27 is in close contact with an inner top surface of the track strip 10. First ventilation holes 271 are formed on the top surface of the boss 27. Heat emitted by the driving power supply 24 may be directly and quickly dissipated from the first ventilation holes 271, then transferred to the track strip 10, and dissipated from the track strip 10. A number of second ventilation holes 211 are provided within a region other than the boss 27 on the upper housing 21. Heat emitted by the LED light bar is dissipated from the second ventilation holes 211, then transferred to the track strip 10, and dissipated from the track strip 10. The design of the first ventilation holes 271 and the second ventilation holes 211 allows the LED strip lights 20 to remain at a stable temperature, improves the stability and service life of the LED strip lights 20 when in use, and also improves the safety.

The LED strip lights 20 are in sliding connection to the track strip 10, grooves are provided on two sides of an inner wall of the track strip 10, and a track switch 28 is provided on the upper housing 21 of the LED strip light 20. The track switch 20 includes a rotary handle 281 and a snap-in member. The snap-in member includes two elastic sheets 282 which are arranged horizontally in opposite directions. One end of each of the elastic sheets 282 is fixed on the upper housing 21, while the other end thereof is a free end arranged horizontally. The rotary handle 281 may control the rotation of the elastic sheets 282. When the rotary handle 282 is rotated right, the electric sheets 282 are corresponding rotated to be horizontal, and the free ends of the two elastic sheets 282 are embedded into the two corresponding grooves of the track strip 10 so that the LED strip lights 20 are fixed on the track strip 10. If it is to remove the LED strip lights 20, it is only required to rotate the rotary handle 281 back to the original position, so that the elastic sheets 282 comes out from the grooves of the track strip and are then rotated to vertical positions, and the LED strip lights 20 may be removed from the track strip 10.

The driving power supply 24 includes a PCB board 241. Insert elements (not shown) are provided on the upper surface of the PCB board 241. The insert elements are a resistor, an inductor, a metal film capacitor, an MOS transistor, and inductor and a capacitor, which are successively arranged on the PCB board 241. SMD elements electrically connected to the insert elements are provided on the lower surface of the PCB board 241.

In conclusion, in the track strip light provided by the present patent, by providing track spotlights 30 and LED strip lights 20 and mounting both the track spotlights 30 and the LED strip lights 20 inside the track strip, the characteristics and space of the track strip is fully utilized; the track strip light may realize general lighting while realizing accent lighting; the mounting space is saved; and it is easy to disassemble and assemble. In addition, with regard to the track strip light, the number of lamps can be increased or reduced according to the height of a track, and the positions of the LED strip lights and the track spotlights can be arbitrarily adjusted according to actual requirements, leading to high flexibility.

The foregoing embodiment is merely an implementation of the present invention. The description of the foregoing embodiment is specific and detailed, but it shall not be interpreted as limiting the patent scope of the present patent. It should be pointed out that, a person of ordinary skill in the art may make some variations and improvements without departing from the concept of the present patent, and these variations and improvements shall fall into the protection scope of the present patent. Therefore, the protection scope of the present patent patent shall be subject to the appended claims.

What is claimed is:

1. A track strip light, comprising a track strip, a number of LED strip lights and a number of track spotlights, wherein both the LED strip lights and the track spotlights are mounted on the track strip, and can freely move on the track strip to allow the positions thereof to be adjusted according to actual requirements; grooves are provided on two inner faces inside the track strip; each of the LED strip light comprises a housing, an LED light bar and a driving power supply, the housing comprising a lower housing and an upper housing adapted onto the lower housing, the lower housing and the upper housing forming an accommodation space in which the LED light bar and the driving power supply are mounted; a track switch is provided on the LED strip light, and a snap-in member is provided on the track switch; when the LED strip lights are mounted, the LED strip lights are embedded into the track strip, and the rack switch is rotated so that the snap-in portion is snapped into the grooves of the track strip, and accordingly, the LED strip lights are fixed inside the track strip;
and, when it is to remove the LED strip lights, the track switch is rotated back to the original position, and the snap-in portion comes out from the grooves, so that the LED strip lights can be removed, and it is convenient for disassembly and assembly.

2. The track strip light according to claim 1, wherein the lower housing is detachably mounted on the upper housing, and the lower housing is made of a transparent material.

3. The track strip light according to claim 1, wherein a boss is convexly provided in the middle of the top of the upper housing, and the top of the boss is in close fit with an inner wall of the track strip.

4. The track strip light according to claim 3, wherein a mounting portion is provided on an inner top surface of the upper housing, the LED light bar is fixed on the mounting portion by a fastener, and the driving power supply is mounted inside the boss.

5. The track strip light according to claim 3, wherein a number of first ventilation holes are provided on a top surface of the boss, and heat generated by the driving power supply is dissipated from the first ventilation holes.

6. The track strip light according to claim 3, wherein a number of second ventilation holes are provided within a region other than the boss on the top surface of the upper housing, and heat generated by the LED light bar is dissipated from the second ventilation holes.

7. The track strip light according to claim 1, wherein the track switch is arranged on the top surface of the upper housing of the LED strip lights; and the snap-in member comprises a number of elastic sheets, one end of each of which is fixed on the LED strip lights while the other end thereof is snapped into the groove on the inner side face of the track so that the LED strip lights are fixed in the track strip.

8. The track strip light according to claim 7, wherein grooves are provided on two side faces of the track strip; and the snap-in member comprises two elastic sheets which are arranged horizontally in opposite directions, and the two electric sheets are embedded into the grooves on the two inner side faces of the track strip, respectively.

9. The track strip light according to claim 1, wherein a hook is provided on the lower housing, a hole matched with the hook is provided on the upper housing, and the hook is buckled in the hole.

10. The track strip light according to claim 1, wherein the track strip is made of aluminum.
